(19) United States
(12) Patent Application Publication
(10) Pub. No.: US 2026/0010826 A1
(43) Pub. Date: Jan. 8, 2026

(54) METHOD AND APPARATUS FOR PREDICTIVE MODELING OF A CONTROLLER AREA NETWORK SIGNAL

(71) Applicants: HYUNDAI MOTOR COMPANY, Seoul (KR); KIA CORPORATION, Seoul (KR)

(72) Inventors: Tac Koon Kim, Hwaseong-si (KR); Bu Yeol Ryu, Hwaseong-si (KR); Jong Hwa Lee, Hwaseong-si (KR)

(73) Assignees: HYUNDAI MOTOR COMPANY, Seoul (KR); KIA CORPORATION, Seoul (KR)

(21) Appl. No.: 18/973,822

(22) Filed: Dec. 9, 2024

(30) Foreign Application Priority Data
Jul. 5, 2024 (KR) 10-2024-0088909

(51) Int. Cl. G06N 20/00

(52) U.S. Cl. CPC G06N 20/00

(57) ABSTRACT

A method for predictive modeling of a controller area network (CAN) signal includes managing training data based on a CAN signal. Managing the training data includes analyzing the CAN signal and selecting a feature based on a degree of correlation. The method also includes performing training on an artificial intelligence (AI) model based on the training data.

### CROSS-REFERENCE TO RELATED APPLICATION

This application claims priority to and the benefit of Korean Patent Application No. 10-2024-0088909, filed on Jul. 5, 2024, the entire contents of which are hereby incorporated herein by reference.

### BACKGROUND

### Field of the Invention

The present disclosure relates to a method and apparatus for predictive modeling of a controller area network signal, and more particularly, to an AI-based CAN signal prediction model using super transformational machine learning (TML).

### Discussion of Related Art

When integrated control-based vehicle systems are introduced, it is expected that unnecessary sensors will not be used and missing sensor values will be predicted based on major sensor values. To predict such sensor values, AI-based modeling may be used.

Existing methods have a problem that a user has to configure and design the architecture himself or herself, which takes a long time.

### SUMMARY

Embodiments of the present disclosure provide a method and apparatus for predictive modeling of a controller area network signal.

According to an aspect of the present disclosure, a method for predictive modeling of a controller area network (CAN) signal is provided. The method includes managing training data based on a CAN signal and performing training on an artificial intelligence (AI) model based on the training data. Managing the training data includes analyzing the CAN signal and selecting a feature based on a degree of correlation.

In an embodiment, managing the training data may further include computing a linear correlation value of a target signal and an input signal.

In an embodiment, managing the training data may further include removing multicollinearity based on the Jensen-Shannon divergence (JSD) of the target signal and the input signal.

In an embodiment, managing the training data may further include augmenting data based on an output value, and in the augmenting of the data, the data may be augmented using the Synthetic Minority Over-Sampling Technique (SMOTE).

In an embodiment, managing the training data may further include transforming the CAN signal into an image or embedding.

In an embodiment, in the transforming of the CAN signal, numbers of features may be listed and the numbers may be arranged with different font sizes depending on importance of the features.

In an embodiment, performing the training on the AI model based on the training data may further include selecting a pre-trained model and adding an output layer of the pre-trained model.

According to another aspect of the present disclosure, an apparatus for predictive modeling of a controller area network (CAN) signal is provided. The apparatus includes a training data management unit configured to manage training data based on a CAN signal and an artificial intelligence (AI) model training unit configured to perform training on an AI model based on the training data. The training data management unit is configured to analyze the CAN signal and select a feature based on a degree of correlation.

In an embodiment, the training data management unit may compute a linear correlation value of a target signal and an input signal.

In an embodiment, the training data management unit may remove multicollinearity based on the Jensen-Shannon divergence (JSD) of the target signal and the input signal.

In an embodiment, the training data management unit may augment data based on an output value, and may augment the data using the Synthetic Minority Over-Sampling Technique (SMOTE).

In an embodiment, the training data management unit may transform the CAN signal into an image or embedding.

In an embodiment, the training data management unit may list the numbers of features and arrange numbers with different font sizes depending on importance of the features.

In an embodiment, the AI model training unit may select a pre-trained model and add an output layer of the pre-trained model.

### BRIEF DESCRIPTION OF THE DRAWINGS

The above and other objects, features, and advantages of the present disclosure should become more apparent to those of ordinary skill in the art from the following description taken in conjunction with the accompanying drawings, in which:

FIG. 1 is a flowchart of a method for predictive modeling of a controller area network (CAN) signal according to an embodiment;

FIG. 2 is a diagram showing a method for predictive modeling of a CAN signal according to an embodiment;

FIG. 3 is a diagram showing 2D embedding according to an embodiment;

FIG. 4 is a code and graph using a random forest for 2D embedding according to an embodiment;

FIG. 5 is a diagram showing an example of using a VGG Net according to an embodiment;

FIG. 6 is a diagram showing a flowchart configuration for model training and verification according to an embodiment; and

FIG. 7 is a block diagram of an apparatus for predictive modeling of the CAN signal.

### DETAILED DESCRIPTION

Hereinafter, with reference to the accompanying drawings, embodiments of the present disclosure are described in detail to enable those having ordinary skill in the art to practice the embodiments. However, the present disclosure may be implemented in many different forms and is not limited to the embodiments described herein.

In describing embodiments of the present disclosure, where it was determined that a detailed description of a known configuration or function may obscure the gist of the present disclosure, the detailed description thereof has been omitted. In addition, in the drawings, parts that are not related to the description of the present disclosure are omitted, and similar parts are given similar reference numerals.

In the present disclosure, when a component is said to be “connected,” “joined” or “coupled” to another component, this may include not only a direct connection relationship between the component and the other component, but also an indirect connection relationship where one or more other components exist in between. In addition, when a component is said to “include,” “comprise,” “have,” or the like, another component, this does not mean that other components are excluded, but rather other components may be further included unless specifically stated to the contrary.

In the present disclosure, terms such as “first,” “second,” etc. are used only for the purpose of distinguishing one component from other components, and do not limit the order or importance between components unless specifically mentioned. Accordingly, within the scope of the present disclosure, a first component in an embodiment may be referred to as a second component in another embodiment, and similarly, a second component in an embodiment may be referred to as a first component in another embodiment.

In the present disclosure, when components are described as being distinct from each other, it is intended to clearly describe their respective features, and does not necessarily mean that the components are separated. For example, a plurality of components may be integrated to form a single hardware or software unit, or a single component may be distributed to form a plurality of hardware or software units. Accordingly, even if not specifically mentioned, such integrated or distributed embodiments are also included within the scope of the present disclosure.

In the present disclosure, components described in various embodiments are not necessarily essential components. Rather, some described components may be optional components. Accordingly, embodiments configured with a subset of components described in an embodiment are also included within the scope of the present disclosure. In addition, embodiments that include other components in addition to the components described in various embodiments are also included within the scope of the present disclosure.

In the present disclosure, phrases such as “A or B,” “at least one of A and B,” “at least one of A or B,” “A, B, or C,” “at least one of A, B, and C,” and “at least one of A, B, C, or a combination thereof” may include any one of the items listed together with the corresponding phrase among the phrases, or all possible combinations thereof.

When a component, device, unit, element, or the like of the present disclosure is described as having a purpose or performing an operation, function, or the like, the component, device, or element should be considered herein as being “configured to” meet that purpose or perform that operation or function.

The advantages and features of the present disclosure and methods for achieving them should be more clearly understood from the detailed description below along with the accompanying drawings. However, the present disclosure is not limited to the embodiments presented below and may be implemented in various different forms. The described embodiments are merely provided to ensure that the present disclosure is complete and to fully inform those having ordinary skill in the art to which the present disclosure pertains of the scope of the present disclosure.

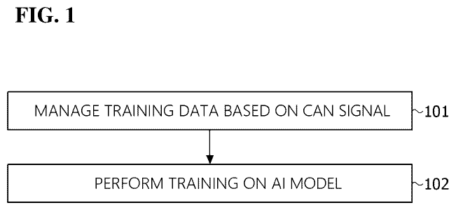

FIG. 1 is a flowchart of a method for predictive modeling of a CAN signal according to an embodiment.

According to an embodiment, each operation of a method for predictive modeling of a CAN signal may be performed by at least some components of an apparatus for predictive modeling of the CAN signal. An example apparatus for predictive modeling of the CAN signal, according to an embodiment, is described below.

In an operation 101, the apparatus for predictive modeling of the CAN signal may manage training data based on a CAN signal.

In an operation 102, the apparatus for predictive modeling of the CAN signal may perform training on an artificial intelligence (AI) model based on the training data.

The apparatus for predictive modeling of the CAN signal may analyze the CAN signal and may select a feature based on a degree of correlation.

The components of the apparatus for predictive modeling of the CAN signal may include at least some of a machine, a circuit, a semiconductor, a computing device, a memory, a processor, a data transceiver, etc., and at least a portion of each component may be mechanically/physically/communicatively/electrically connected to at least a portion of another component.

According to an embodiment, the apparatus for predictive modeling of the CAN signal may include at least some of all components included in the description below or the accompanying drawings.

According to an embodiment, the apparatus for predictive modeling of the CAN signal may output/transmit/display at least some of all components included in the specification or drawings through a user/administrator terminal or the like. The user/administrator terminal may include at least a portion of a computing device or mobile device.

According to an embodiment, the apparatus for predictive modeling of the CAN signal may perform at least some of all operations or functions included in the description below or the accompanying drawings.

According to an embodiment, the apparatus for predictive modeling of the CAN signal may compute a linear correlation value of a target signal and an input signal.

In an embodiment, the apparatus for predictive modeling of the CAN signal may remove multicollinearity based on the Jensen-Shannon divergence (JSD) of the target signal and the input signal.

In an embodiment, the apparatus for predictive modeling of the CAN signal may augment data based on an output value. In an example, the apparatus for predictive modeling of the CAN signal may augment the data using the Synthetic Minority Over-Sampling Technique (SMOTE).

In an embodiment, the apparatus for predictive modeling of the CAN signal may transform the CAN signal into images or embedding.

In an embodiment, the apparatus for predictive modeling of the CAN signal may list the numbers of features and may arrange the numbers with different font sizes depending on importance of the features.

In an embodiment, the apparatus for predictive modeling of the CAN signal may select a pre-trained model and may add an output layer of the pre-trained model.

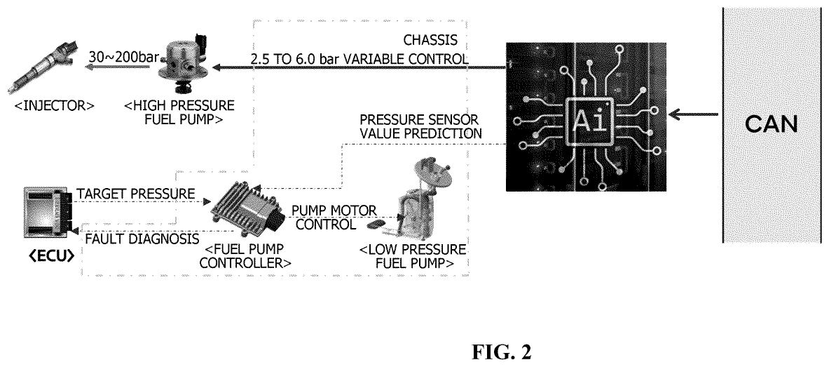

FIG. 2 is a diagram showing a method for predictive modeling of the CAN signal according to an embodiment.

According to an embodiment, the apparatus for predictive modeling of the CAN signal may transform a CAN signal into images by mapping from 1-dimensional data to 2-dimensional data through pixel embedding, and based on this, utilize a backbone model that has been pre-trained based on ImageNet.

Referring to FIG. 2, the apparatus for predictive modeling of the CAN signal may replace the role of a fuel pressure sensor by predicting a fuel pump pressure sensor value using CAN data as an input when a target signal is a low-pressure fuel pressure sensor value.

According to an embodiment, the apparatus for predictive modeling of the CAN signal may choose/select a feature of the CAN signal, may remove multicollinearity, may perform data augmentation, and may perform 2-dimensional (2D) embedding by acquiring and preprocessing training data.

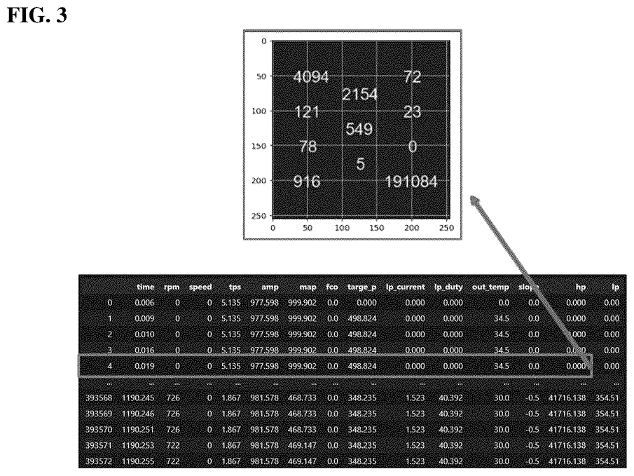

FIG. 3 is a diagram showing 2D embedding according to an embodiment.

According to an embodiment, the apparatus for predictive modeling of the CAN signal may compute a linear correlation value of the target signal and the input signal in order to choose/select the feature of the CAN signal. The apparatus for predictive modeling of the CAN signal may compute a correlation coefficient when predicting the fuel pump pressure sensor value. The apparatus for predictive modeling of the CAN signal may compute a value for correlation or a correlation coefficient between features.

According to an embodiment, the apparatus for predictive modeling of the CAN signal computes a linear correlation coefficient and leaves only a feature highly correlated with the target signal, and a correlation coefficient threshold may be chosen/selected through the results of a model.

According to an embodiment, when respective features are highly correlated, the apparatus for predictive modeling of the CAN signal may leave only one of the corresponding features and delete the remaining features in order to remove multicollinearity. In this case, a determination standard may be based on the JSD, as described in more detail below.

According to an embodiment, the multicollinearity may prevent generalization of a predictive model due to strong correlation between independent variables.

According to an embodiment, since multicollinearity may occur when the correlation coefficients of features are high, the apparatus for predictive modeling of the CAN signal may leave only one feature among the features having a high correlation coefficient and delete the remaining features in order to remove multicollinearity. In this case, the standard may be set as follows
\textcircled{1} Compute the JSD of an input feature and a target value.
\textcircled{2} In this case, the higher the JSD, the higher the entropy the two features have, and thus an amount of information the two features have is greater.
\textcircled{3} When the JSD of the input feature is high, the input feature is maintained, and if the input feature has relatively low JSD, the input feature is deleted.

According to an embodiment, as the target value, values within a specific boundary are mainly output and the remaining values are output in relatively small quantities, resulting in data imbalance. Accordingly, the apparatus for predictive modeling of the CAN signal may utilize/perform data augmentation to prevent overfitting.

According to an embodiment, the apparatus for predictive modeling of the CAN signal may exploit/use/utilize an over-sampling method that augments data based on the most frequently output value and may perform augmentation using the SMOTE among over-sampling methods.

The SMOTE operation method is to draw a straight line between random minority class data and create new data on that straight line. The pressure sensor output value (target value) may be utilized/used/checked by comparing data before and after the SMOTE when predicting the fuel pump pressure sensor value.

Referring to FIG. 3, the apparatus for predictive modeling of the CAN signal may perform 2D embedding, and may perform a process of transforming the CAN signal, which is 1-dimensional data, into 2-dimensional images or by 2-dimensional embedding in order to utilize a pre-trained convolutional neural network (CNN) model based on ImageNet Dataset.

According to an embodiment, the apparatus for predictive modeling of the CAN signal may perform imaging of the CAN signal by listing the numbers of features.

According to an embodiment, the apparatus for predictive modeling of the CAN signal may arrange numbers in larger character sizes/font sizes depending on importance of the features. In an example, the apparatus for predictive modeling of the CAN signal may compute the importance of the features.

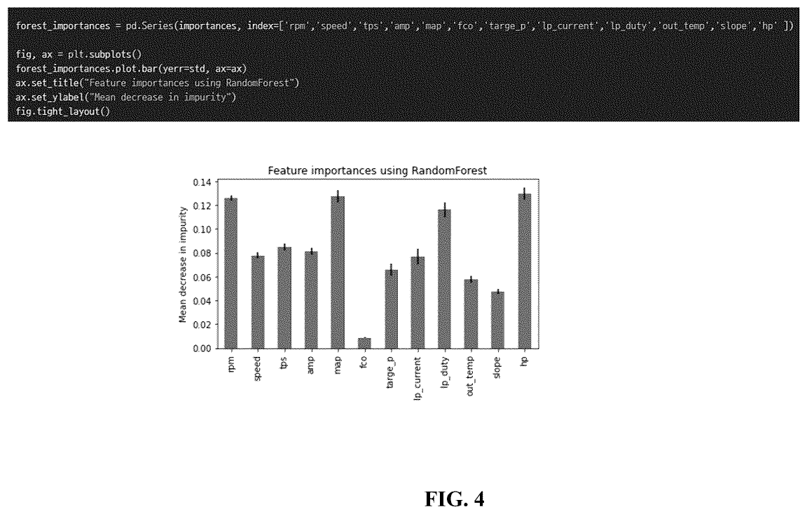

FIG. 4 is a code and graph using a random forest for 2D embedding according to an embodiment.

According to an embodiment, the apparatus for predictive modeling of the CAN signal may perform the 2D embedding and may calculate importance.

According to an embodiment, the apparatus for predictive modeling of the CAN signal may compute importance of features on the basis of/based on the results of the random forest and may use the feature importance as the importance.

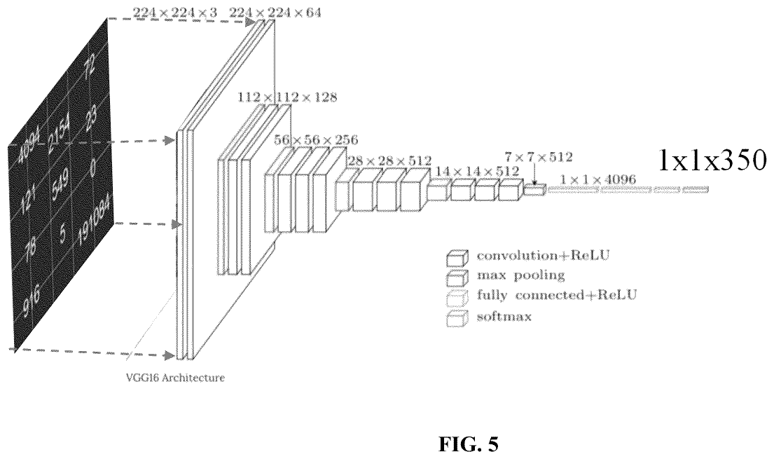

FIG. 5 is a diagram showing an example of using a Visual Geometry Group (VGG) Net according to an embodiment.

According to an embodiment, the apparatus for predictive modeling of the CAN signal may choose/select a pre-trained model for building and training the AI model.

According to an embodiment, the apparatus for predictive modeling of the CAN signal may be used by choosing/selecting a pre-trained model from those distributed as pre-trained models based on ImageNet. The pre-trained models may include AlexNet, VGGNet, ResNet, etc.

According to an embodiment, the apparatus for predictive modeling of the CAN signal may add an output layer of the pre-trained model for building and training the AI model.

According to an embodiment, the apparatus for predictive modeling of the CAN signal may select the number of nodes of an output layer according to the measurement/size/dimension of a target value to be predicted. For example, in the case of a fuel pump pressure sensor value prediction model, there may be 350 outputs/output labels/values from 0 to 349.

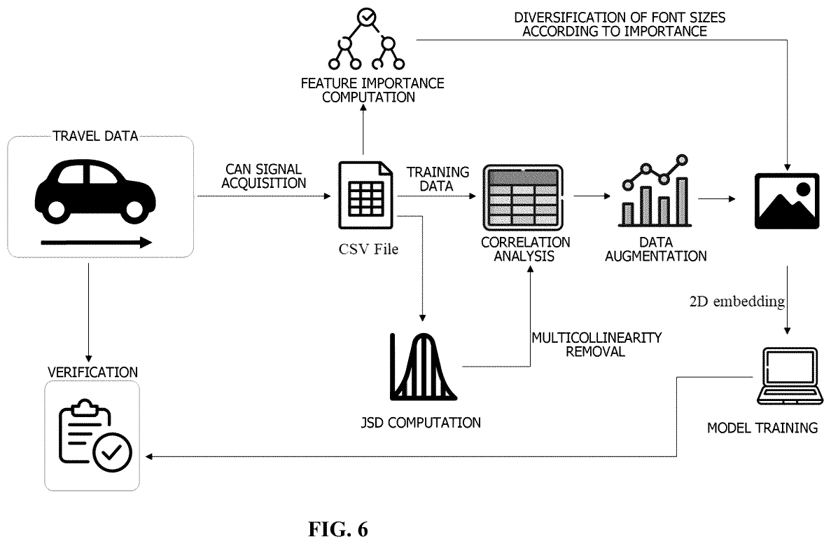

FIG. 6 is a diagram showing a flowchart configuration for model training and verification according to an embodiment.

According to an embodiment, the apparatus for predictive modeling of the CAN signal may perform an analysis and feature selection process of the CAN signal, may select which features to use for model training, and may establish/set a clear standard.

According to an embodiment, the apparatus for predictive modeling of the CAN signal may use an augmentation algorithm when augmenting data. In an example, the apparatus for predictive modeling of the CAN signal may use an augmentation method verified on the basis of/based on CAN signal data because the augmentation scheme has a significant effect on the accuracy of the model.

According to an embodiment, the apparatus for predictive modeling of the CAN signal may increase learning accuracy by making each number different in font size using feature importance during 2D embedding.

According to an embodiment, the apparatus for predictive modeling of the CAN signal may exhibit high performance with a small amount of data using a pre-trained model.

According to an embodiment, the apparatus for predictive modeling of the CAN signal may use a 2D-CNN model whose excellent performance has been verified. The apparatus for predictive modeling of the CAN signal has the advantage of being able to be used simply by tuning without the need to go through a validation and verification process when building the model.

According to an embodiment, the apparatus for predictive modeling of the CAN signal is easy to use because verification data can be used directly in tabular form without image transformation. The apparatus for predictive modeling of the CAN signal may use 2D embeddings only during training and make predictions through tabular data when applying 2D embeddings to an actual model.

According to an embodiment, the apparatus for predictive modeling of the CAN signal may be universally used for various CAN signals. The apparatus for predictive modeling of the CAN signal has the effect of being able to perform training and make predictions by putting/inputting only the 2D embedding image (input) differently after building a basic model.

According to an embodiment, the apparatus for predictive modeling of the CAN signal has an effect of being able to produce an output with excellent performance with small-scale data. The apparatus for predictive modeling of the CAN signal uses a pre-trained model based on ImageNet, and thus the apparatus for predictive modeling of the CAN signal is able to immediately produce an output with excellent performance with a small amount of data.

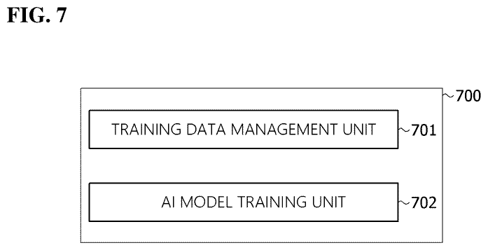

FIG. 7 is a block diagram of an apparatus for predictive modeling of the CAN signal, according to an embodiment.

According to an embodiment, an apparatus 700 for predictive modeling of the CAN signal may include a training data management unit 701 that manages training data based on a CAN signal and an AI model training unit 702 that performs training on an AI model based on the training data.

The training data management unit 701 may analyze the CAN signal and may select a feature based on a degree of correlation.

According to an embodiment, the training data management unit 701 may compute a linear correlation value of a target signal and an input signal.

According to an embodiment, the training data management unit 701 may remove multicollinearity based on the JSD of the target signal and the input signal.

According to an embodiment, the training data management unit 701 may augment data based on an output value. In an example, the training data management unit 701 may augment the data using the SMOTE.

According to an embodiment, the training data management unit 701 may transform the CAN signal into images or embeddings.

According to an embodiment, the training data management unit 701 may list the numbers of features and arrange the numbers with different font sizes depending on importance of the features.

According to an embodiment, the AI model training unit 702 may select a pre-trained model and add an output layer of the pre-trained model.

The term “unit” as used herein may refer to a software or hardware component such as a field-programmable gate array (FPGA) or an application-specific integrated circuit (ASIC), and a “unit” nay perform a certain role. However, a “unit” is not limited to software or hardware. A “unit” may reside in an addressable storage medium and may be executable by one or more processors. Accordingly, as an example, a “unit” includes a component such as a software component, an object-oriented software component, a class component, a task component, etc., a process, a function, an attribute, a procedure, a subroutine, a segment of program code, a driver, firmware, microcode, a circuit, data, a database, a data structure, a table, an array, or a variable. The functions provided within the components and “units” may be combined into a smaller number of components and “units” or may be further separated into additional components and “units.” In addition, components and “units” may be implemented to regenerate one or more CPUs within a device or a secure multimedia card.

Although the above description refers to example embodiments of the present disclosure, those having ordinary skill in the art should understand that various modifications and changes may be made to the described embodiments without departing from the spirit and scope of the present disclosure as set forth in the appended claims.

Although the example methods of the present disclosure described above are expressed as a series of operations for clarity of description, this is not intended to restrict the order in which steps are performed. For example, respective steps may be performed simultaneously or in a different order. In order to implement the methods according to the present disclosure, other steps may be included in addition to the described steps, some steps may be excluded and the remaining steps may be included, and/or some steps may be excluded and additional other steps may be included.

The various embodiments of the present disclosure do not list all possible combinations thereof, but describe representative aspects of the present disclosure, and matters described in various embodiments may be applied independently or in a combination of two or more.

In addition, various embodiments of the present disclosure may be implemented by hardware, firmware, software, or a combination thereof. In the case of implementation by hardware, various embodiments of the present disclosure may be implemented by one or more ASICs, digital signal processors (DSPs), digital signal processing devices (DSPDs), programmable logic devices (PLDs), FPGAs, general processors, controllers, microcontrollers, microprocessors, etc.

The scope of the present disclosure includes software or machine-executable instructions (e.g., an operating system, an application, firmware, a program, etc.) that cause operations according to methods of various embodiments to be executed on a device or computer, and a non-transitory computer-readable medium in which such software or machine-executable instructions, etc. are stored and can be executed on a device or computer.

What is claimed is:

1. A method for predictive modeling of a controller area network (CAN) signal, the method comprising:
managing training data based on a CAN signal; and
performing training on an artificial intelligence (AI) model based on the training data,
wherein managing the training data includes
analyzing the CAN signal, and
selecting a feature based on a degree of correlation.

2. The method of claim 1, wherein managing the training data further includes computing a linear correlation value of a target signal and an input signal.

3. The method of claim 2, wherein managing the training data further includes removing multicollinearity based on a Jensen-Shannon divergence (JSD) of the target signal and the input signal.

4. The method of claim 1, wherein managing the training data further includes augmenting data based on an output value, wherein augmenting the data includes performing data augmentation using a Synthetic Minority Over-Sampling Technique (SMOTE).

5. The method of claim 1, wherein managing the training data further includes transforming the CAN signal into an image or embedding.

6. The method of claim 5, wherein, in the transforming of the CAN signal, numbers of features are listed, and wherein the numbers of features are arranged with different font sizes depending on importance of the features.

7. The method of claim 1, wherein performing the training on the AI model based on the training data further includes:
selecting a pre-trained model; and
adding an output layer of the pre-trained model.

8. An apparatus for predictive modeling of a controller area network (CAN) signal, the apparatus comprising:
a training data management unit configured to manage training data based on a CAN signal; and
an artificial intelligence (AI) model training unit configured to perform training on an AI model based on the training data,
wherein the training data management unit is configured to analyze the CAN signal and select a feature based on a degree of correlation.

9. The apparatus of claim 8, wherein the training data management unit is configured to compute a linear correlation value of a target signal and an input signal.

10. The apparatus of claim 9, wherein the training data management unit is configured to remove multicollinearity based on a Jensen-Shannon divergence (JSD) of the target signal and the input signal.

11. The apparatus of claim 8, wherein the training data management unit is configured to augment data based on an output value, wherein augmenting the data includes performing data augmentation using a Synthetic Minority Over-Sampling Technique (SMOTE).

12. The apparatus of claim 8, wherein the training data management unit is configured to transform the CAN signal into an image or embedding.

13. The apparatus of claim 12, wherein the training data management unit is configured to list numbers of features and arrange the numbers of features with different font sizes depending on importance of the features.

14. The apparatus of claim 8, wherein the AI model training unit is configured to select a pre-trained model and add an output layer of the pre-trained model.
